(19) United States
(12) Patent Application Publication
(10) Pub. No.: US 2005/0242574 A1
(43) Pub. Date: Nov. 3, 2005

(54) Support apparatus and method

(76) Inventor: Ronald Cowie, Aberdeen (GB)

Correspondence Address: Pepper Hamilton LLP;Firm 21269, One Mellon Center, 50th Floor, 500 Grant Street, Pittsburgh, PA, 15219, US

(21) Appl. No.: 11/111,331

(22) Filed: Apr. 21, 2005

(30) Foreign Application Priority Data
Apr. 22, 2004 (GB) 0408944.7

(51) Int. Cl. F16L 21/00; F16L 37/00

(52) U.S. Cl. 285/146.1

(57) ABSTRACT

At least first and second substantially rigid tubular members having a through bore, and in most instances more than two tubulars, are connected together to form a support apparatus such that a moveable joint is provided between the first and second tubular members. The members typically form a conduit inserted into a substantially flexible tubing, where the support apparatus prevents crushing or collapse of the flexible tubing in environments having a higher exterior pressure with respect to the interior pressure of the flexible tubing, such as subsea environments. The moveable joint typically permits articulated or pivoting movement to occur between the first and second tubular members.

### RELATED APPLICATIONS AND CLAIM OF PRIORITY

This application claims priority to United Kingdom patent application no. 0408944.7, filed Apr. 22, 2004, which is hereby incorporated by reference in its entirety.

### TECHNICAL FIELD

The present invention relates to support apparatus and a method for supporting substantially flexible tubing or hose, more particularly but not exclusively, relates to flexible hose support apparatus for use deep subsea in the hydrocarbon exploration and production industry.

### BACKGROUND OF THE INVENTION

In the hydrocarbon exploration and production industry it is often necessary to provide fluid communication and/or transfer fluids, for example drilling fluid, hydraulic fluid, production fluid etc. from one piece of subsea equipment to another piece of subsea equipment. This is typically performed by connecting a length of flexible tubing between fluid ports on each piece of subsea equipment and transferring the fluid there along. Using flexible tubing for this purpose is preferable to using rigid tubing since the flexibility of the tubing allows it to be connected to each piece of equipment relatively easily. In addition, when attached at each end, each piece of equipment may move with respect to one another without the need for the tubing to be disconnected.

The flexibility of such tubing is obtained by manufacturing the tubing from a relatively thin walled suitable material such as an elastomeric material although the tubing is usually reinforced with integral helically coiled lengths of steel wire in order to provide some measure of strength to the tubing. However, the requirement for the tubing to be relatively lightweight and to have relatively thin walls can often result in the tubing collapsing due to the large hydrostatic pressure exerted on it by the large depth of water above it in typical subsea operating conditions.

Though flexible tubing is generally manufactured with the helically arranged reinforcing wires integrated into the tubing walls, this is limited to being relatively thin so that it does not adversely affect the flexibility of the tubing and is therefore often not sufficiently rigid enough to prevent the flexible tubing from collapsing under pressure.

### SUMMARY OF THE INVENTION

According to the present invention there is provided a method of supporting tubing, the method comprising the steps of: inserting at least first and second substantially rigid tubular members into the tubing, each substantially rigid member comprising a through bore; and connecting the first and second tubular members such that a moveable joint is provided between the first and second tubular members.

Typically, the method results in that collapse of the tubing, which may be a relatively flexible hose, is substantially prevented whereby an outer surface of the tubular members provides a support to an inner surface of the flexible hose.

Typically, the method further comprises placing the tubing in water in use of the tubing to provide a fluid communication path, and the method typically further comprises the tubular members substantially preventing collapse of the flexible hose when a differential pressure is acting to attempt to collapse the flexible hose.

According to the present invention there is also provided support apparatus comprising: at least first and second substantially rigid tubular members each comprising a through bore; and connection means for selectively connecting the first and second tubular members such that a moveable joint is provided between the first and second tubular members.

Typically, the support apparatus comprises a conduit which is preferably adapted to be inserted into a substantially flexible tubing or hose where the support apparatus is preferably adapted to prevent crushing or collapse of the flexible tubing or hose particularly where the flexible tubing or hose is used in environments having a higher exterior pressure with respect to the interior pressure of the flexible tubing or hose.

Preferably, the moveable joint provided by the connection means permits articulated movement to occur between the first and second tubular members. The articulated movement permitted typically comprises movement of the first and second members in a pivoting relationship which may be movement of a longitudinal axis of the first tubular member with respect to a longitudinal axis of the second tubular member within a cone projecting away from the end of the second tubular member, the closest ends of the pair of longitudinal axes preferably remaining intersected at the same point whilst the first and second tubular members are connected. Most preferably, the connection means comprises a ball joint provided on one of the first and second tubular members and a socket joint provided on the other of the first and second tubular members.

Preferably, the connection means is adapted to substantially prevent longitudinal movement of the first tubular member with respect to the second tubular member.

Preferably the connection means comprises a female or socket connection portion on one of the first and second tubular members and a male or ball connection portion on the other of the first and second tubular members. More preferably, the connection means further comprises a retaining lip on the female connection portion adapted to be retained within a lip retaining groove which is preferably provided adjacent the male connection portion. Preferably, the retaining lip is provided with a radius which assists connection of the female connection portion to the male connection portion.

Typically, the first tubular member is provided with a female connection portion and a male connection portion, the latter of which may typically be connected to the female connection portion of the second tubular member. This connection is typically performed until the desired length of the apparatus is achieved.

Alternatively, the first tubular member is provided with first and second male connection portions which may be connected to a second tubular member having first and second female connection portions. Such tubular members may be alternately connected until the desired length of apparatus is achieved.

Typically, a plurality of tubular members are provided such that when the plurality of tubular members are connected to one another, one end of the apparatus may be angularly displaced with respect to the other without substantially tensioning or compressing the tubular members.

This provides a support apparatus which may be formed from substantially rigid tubular members but which allows the apparatus as a whole to flex.

Preferably, the support apparatus is provided with at least a tubing connection socket which is adapted to allow connection of a portion of the apparatus to flexible tubing/hose. Preferably, the tubing connection socket is provided with a gripping portion adapted to allow the flexible tubing to be gripped on the tubing connection socket. Preferably, the tubing connection socket is provided with connection means having a male connecting portion adapted to engage with the female connection portion of at least one tubular member. Alternatively, the tubing connection socket is provided with connection means having a female connection portion adapted to engage with the male connection portion of at least one tubular member.

Preferably, the tubing connection socket is provided with attachment means adapted to allow attachment of the tubing connection socket to further discrete components. Preferably, the attachment means comprises a joint which may comprise a thread formed thereon.

Typically, a tubular connection member having first and second female connection portions may be provided in order to provide connection between a male connection portion of a tubular member and a male connection portion of the tubing connection socket.

Optionally and/or alternatively, the connection means may comprise further retaining means in order to retain a portion of the first tubular member in engagement with the second tubular member. Optionally, the further retaining means comprises a wire or other suitable member inserted between a portion of the first and second tubular members.

### BRIEF DESCRIPTION OF THE DRAWINGS

Embodiments of the present invention will now be described, by way of example only, with reference to the following drawings, in which:

FIG. 1 is a cross sectional view of the apparatus in accordance with the present invention showing one link of the apparatus in a flexed position;

FIG. 2 is a detailed cross sectional view of a male-female link of the apparatus of FIG. 1;

FIG. 3 is a detailed cross sectional view of a female-female link to be used in conjunction with the apparatus of FIG. 1;

FIG. 4 is a schematic diagram of a tail piece to be used in conjunction with the apparatus of FIG. 1;

FIG. 5 is a schematic cross sectional diagram illustrating the attachment of the tail piece of FIG. 4 to a flexible hose to be supported;

FIG. 6a is a partial cross sectional view of a less preferred but alternative embodiment of the present invention; and

FIG. 6b is a partial cross sectional view of a less preferred but further alternative embodiment of the present invention.

### DESCRIPTION OF PREFERRED EMBODIMENTS

In the following description it should be noted that the term “flexible tubing” should be regarded as a hose or tubing which has a greater degree of flexibility than a substantially rigid member. In other words, though flexible, the hose or tubing possesses a, not insignificant, degree of rigidity. Also, in the following description the reader should note that the term “male-female” member should be regarded as a member having a male connection at one end and a female connection at the other end, and appropriate permutations of this term used in the following description should be regarded accordingly.

Support apparatus 10 comprises a series of substantially tubular links 12 each having a male end 14 and a female end 16.

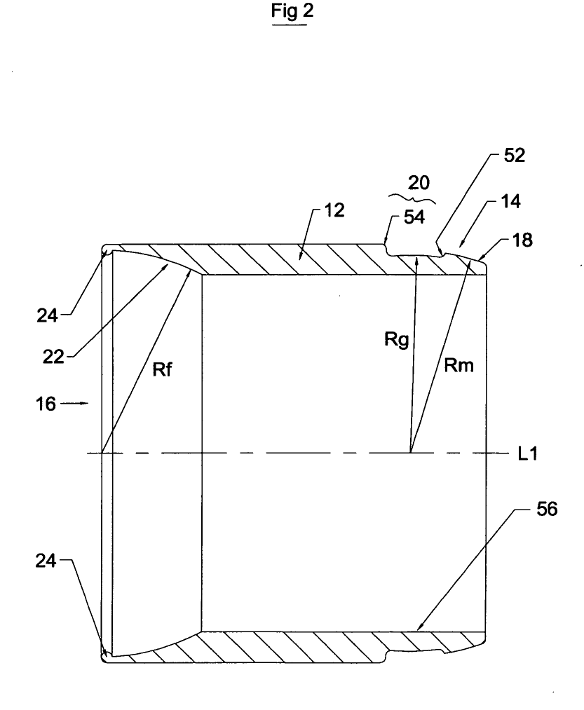

The male end 14 of each link 12 has a surface 18 which is curved by a radius Rₘ (FIG. 2) with respect to the link 12 longitudinal axis, and extends around the circumference of the male end 14 of the link 12. A groove 20 is formed inwardly of curved surface 18, around the outer circumference of a portion of the link 12 adjacent the male end 14 and is curved by a radius R_{g}. A shoulder 52 comprising an angled or radiused face is provided between the curved surface 18 and the groove 20, where the angled or radiused face of the shoulder matches the angle or radius of a bead 24 having a curved surface as will be described subsequently. A second shoulder 54 also comprises a face lying in a direction substantially perpendicular to the longitudinal axis is provided at the other (innermost) end of the groove 20.

The female end 16 of each link 12 has an internal curved surface 22 which tapers by a radius R_{f} from the through bore 56 of the tubular link 12 toward an inwardly projecting bead 24. The bead 24 extends around the inner circumference of the female end 16 and is provided with a curved surface, the purpose of which will be described subsequently.

In this embodiment the radius Rₘ of the curved surface 18 of the male end 14 is manufactured to be the same as the radius R_{f} of female end 16. Typical radii for each of R_{f} and Rₘ in this embodiment would be defined by an arc swept through an angle, the radius of the arc being related to the diameter of the insert links 12, 26. For instance, the radius of the arc may be around 1.9 inches (approximately 48 mm) from the longitudinal axis of the link 12 when the outer diameter of the link 12 is in the region of 3.95 inches. The reason for the similarity in radii, R_{f} and Rₘ, will be described subsequently.

It should also be noted that the outer diameter of the links 12 is manufactured to be at least a sliding fit with the internal diameter of the flexible hose 38 into which the apparatus 10 is to be inserted, as will be subsequently described.

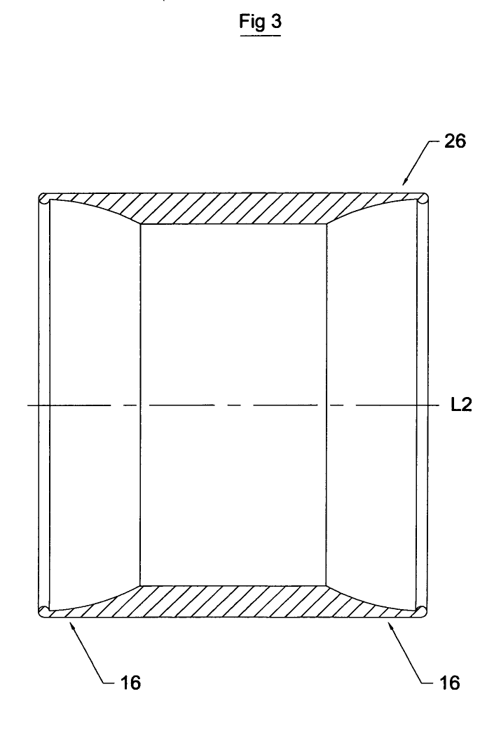

Referring to FIG. 3, a female-female link 26 having a pair of female ends 16 is also provided.

The female-female link 26 is substantially the same as the link 12 previously described with the important difference that it has a female end 16 in place of the male end 14 present on the link 12.

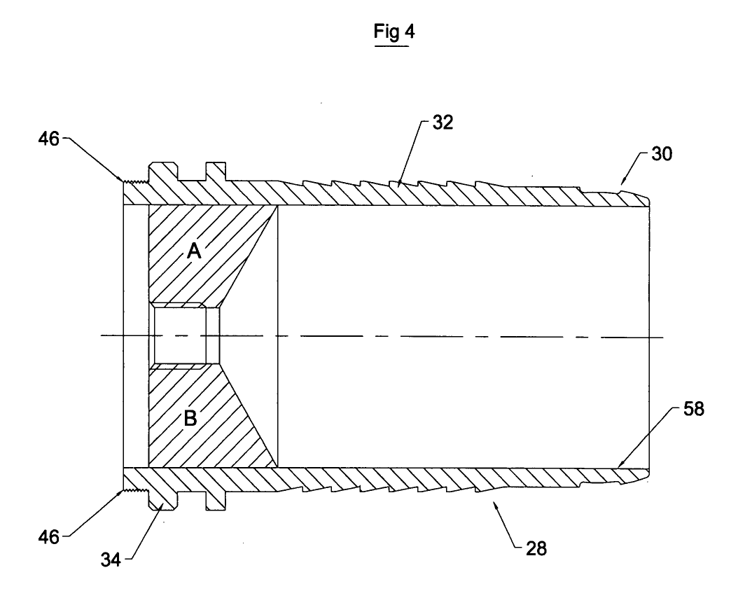

Referring to FIG. 4, a tail piece connector 28 is provided. The tail piece connector 28 comprises a substantially tubular member having a male connection socket 30, a serrated grip 32, and a connection collar 34.

The male connection socket 30 is similar to the male end 14 of each link 12 and therefore no further description of it 30 is necessary.

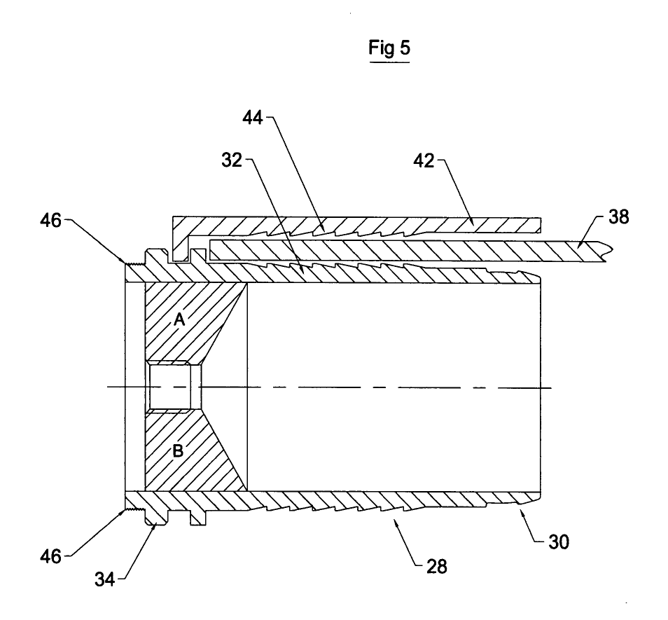

The connector 28 shown in FIG. 4 has a neck A,B which may be used during testing of the apparatus 10; however, in operation, when used to transfer fluid between subsea components, the bore 58 through the tail piece 28 will remain substantially constant from one end to the other. In this regard, the reader should note that in operation the shaded sections A and B (shown in FIGS. 4 and 5) are omitted. In addition, a joint 46 is provided in order to allow connection of the apparatus 10 to subsea equipment. The joint 46 may be threaded (as shown in FIG. 4) or may be in the form of a flange (not shown) and may be a male joint 46 (as shown in FIG. 4) or may be a female joint (not shown), depending upon the connection required.

The serrated grip 32 has a number of angled protrusions which extend around the circumference of the tail piece 28 and their purpose will be described subsequently.

In use, a number of the links 12 are placed (for instance by sliding action) inside standard flexible tubing 38 (FIG. 5) during installation of the apparatus 10. For the sake of clarity, connection of a first link 12 to a second link 12 will now be described though the skilled reader will realise that the connection operation could be performed using an installation machine (not shown) having a magazine loaded with links 12. In such an automated installation system the magazine elastically deforms the female ends 16 of the links 12 and inserts the deformed female end 16 over the male end 14 (or inserts the male end 14 into the deformed female end 16) of the uppermost link 12 and then progresses each newly inserted link and hence the rest of the apparatus 10 down the inside of the tubing 38.

Whilst installing the female end 16 on the male end 14, the female end 16 of a link 12 is urged against the male end 14 of a further link 12 until the innermost surface of the bead 24 of the female end 16 abuts against the curved surface 18 of the male end 14. Further progression of the female end 16 and hence the bead 24 against the curved surface 18 causes the wall of the female end 16 and in particular the bead 24 to be urged radially outwardly due to the radius Rₘ of the curved surface 18. The curved surface of the bead 24 provides a minimum contact area between the bead 24 and the curved surface 18 which eases insertion of the male end 14 into the female end 16. The radially outward movement of the female end 16 caused by progression of the female end 16 onto the male end 14 continues until the bead 24 reaches the edge of the groove 20, at which point the resilient properties of the female end 16 (which is typically made of steel but may be made from any other suitable material) snaps the bead 24 into the groove 20, and the perpendicularly projecting shoulder 52 prevents the bead 24 from moving back down the curved surface 18. At this point the curved surface 18 of the male end 14 comes into contact with the internal curved surface 22 of the female end 16 and the bead 24 resides within the groove 20. The first link 12 is now securely and moveably connected to the second link 12.

The above connection operation is repeated until a sufficient length of links 12 is created in order that the apparatus 10 substantially resides within the length of the flexible tubing 38.

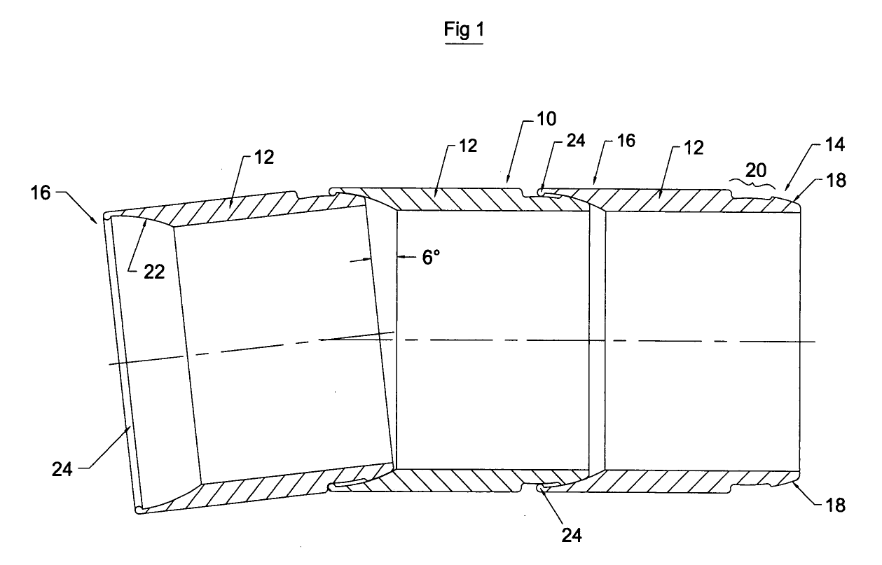

Referring to FIG. 5, the female end 16 of the left hand most end of the apparatus 10 as viewed in FIG. 1 may now be connected to the male end 30 of the tail piece 28 by forcing the female end 16 over the male end 30 in a similar manner to that previously described for connecting each link 12. The flexible tubing 38 is then attached around the outer circumference of the tail piece 28 by sliding it over the serrated grip 32. It should be noted that the angled faces of the serrations allow the tubing 38 to slide onto the serrated grip 32 with relative ease, whereas the opposing flat faced walls prevent the tubing 38 from slipping off the serrated grip 32 by discouraging movement in the opposite direction. In order to attach the tubing 38 to the tail piece 28 more securely and to provide a fluid-tight seal, a ferrule 42 having serrations 44 is crimped (by a suitable crimping tool (not shown)) around the tubing 38 such that the tubing 38 is gripped between the tail piece serrations 32 and the ferrule serrations 44. The ferrule 42 also grips around the collar 34 of the tail piece 28 in order to prevent longitudinal movement of the tail piece 28 in relation to the ferrule 42.

It will be understood by the skilled reader that in this embodiment the apparatus 10 will only normally have one female end 16 which may attach to the male end 30 of a tail piece 28; however by attaching the female-female link 26 to the previously redundant male end 14 of the apparatus 10 it is then possible to connect both ends of the apparatus 10 to a tail piece 28 having a male end 30. This is done by sliding a female end 16 of the female-female link 26 onto the male end 14 of the right hand most end link 12 as seen in FIG. 1 and then sliding the other female end 16 onto the male connector 30 in a similar fashion to that previously described for connection of the links 12.

The apparatus 10 and flexible tubing 38 can then be connected between suitable fluid ports of subsea equipment in order to provide fluid communication and/or transfer fluids there between.

With the tubing 38 and the apparatus 10 now connected between the subsea equipment (not shown), when the ambient pressure surrounding the tubing 38 (due to, for example, the hydrostatic head caused by large depth of water above the apparatus 10) overcomes the structural rigidity of the tubing 38, the tubing 38 will tend to collapse. Leaving the possibility of damaging the tubing 38 aside, this is clearly undesirable since fluid flowing through the tubing 38 will be restricted by any collapsed portion. However, in the present invention, the presence of the links 12 within the tubing 38 provides a non collapsible (under the maximum subsea pressure likely to be experienced) structure 10 upon which the tubing 38 may rest. Thus, in the event that the surrounding pressure causes the tubing 38 to collapse, the diameter of the through bore 56 of the apparatus 10 will not decrease due to the structural integrity provided by the links 12 upon which the partially collapsed tubing 38 will rest. It should be noted that it is not necessary for the connections between the links 12 to be fluid tight since any fluid escaping between the male end 14 and female end 16 of the links 12 will remain inside the fluid tight tubing 38.

During installation of the apparatus 10 and tubing 38 between the subsea equipment (not shown) and indeed once installed on the subsea equipment, the flexibility of the tubing 38 and the apparatus 10 is desirable since, during installation, a degree of flexibility assists in positioning each end of the apparatus 10 on the subsea equipment. The provision of flexibility by the apparatus 10 will now be described.

When a bending moment is applied to the apparatus 10 (by, for example, installation equipment or due to movement of the equipment to which the apparatus 10 is connected) the apparatus 10 is able to articulate or flex (best shown in FIG. 1) due to the curved surfaces on the male 14 and female 16 ends of each link 12. As one link 12 is tilted away from the other, the bead 24 on one side of the link 12 will slide along the radius R_{g} of the groove 20 toward the limit of the groove 20 nearest the male end 14 of the link 12 until it is arrested by shoulder 52, and the bead 24 on the opposite side of the link 12 will slide along the groove 20 toward the limit of the groove 20 nearest the female end 16 of the link 12 until it is arrested by shoulder 54. In other words, the forces exerted on the apparatus 10 by the bending moment are absorbed by the extension of the apparatus 10 on one side (by sliding the bead 24 toward the male end 14) and the contraction of the apparatus 10 on the other side (by sliding the bead 24 toward the female end 16). In this way the closely fitting surfaces of the male 14 and female 16 ends can be considered to be similar to that of a ball socket in that movement (typically around 6 degrees though more may be possible if required) of one link 12 with respect to another link 12 is possible in every angular direction. Moreover, the movement is stable movement due to the large surface area of constant contact between sliding surfaces 18 and 22.

It should be understood that the apparatus 10 may be used to transfer any fluid, for example drilling fluid, hydraulic fluid, production fluid, cooling fluid etc. The outer diameter of the links 12, 26 is typically slightly less than the internal diameter of the flexible tubing/hose 38 it is intended to support. For example, if the internal diameter of the flexible hose is 4″, the external diameter of the links 12, 26 may be 3.95″. A preferred length of link 12, 26 is in the region of 3.5″ but the links 12, 26 could be longer or shorter than this as required. A suitable number of links 12, 26 will be used for the particular flexible hose 38 to be supported; typically, such flexible hoses could be in the region of a few meters in length but could be longer than this if required.

The apparatus 10 therefore provides a flexible tubing system which allows transfer of fluid there along and which cannot collapse due to the pressure of its surrounding environment.

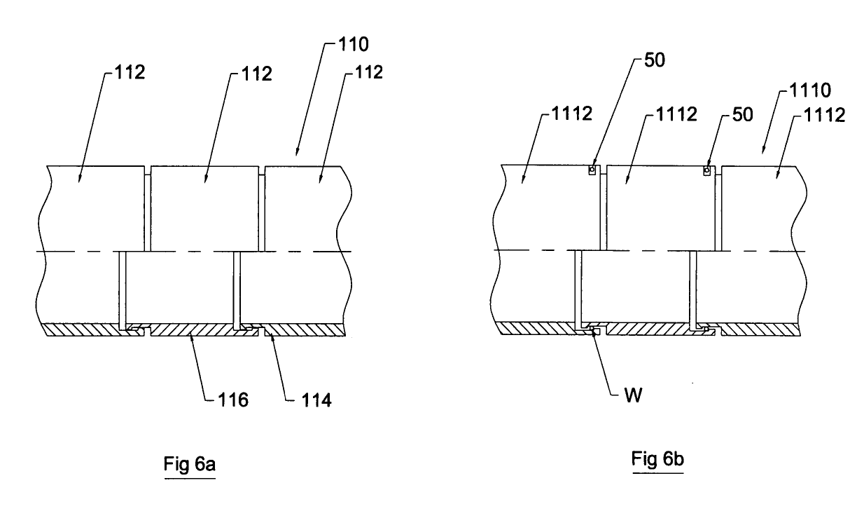

Referring to FIGS. 6a and 6b, alternative but less preferred embodiments of the apparatus will now be described.

Apparatus 110 (FIG. 6a) has tubular links 112 which fit into one another via male 114 and female 116 connection sockets. This embodiment provides the rigidity required for the presently described application; however, the nature of the connection provided by the male 114 and female 116 connection sockets does not as easily allow angular displacement of one end of the apparatus 110 with respect to the other as required in order to maintain the flexibility of the system. Therefore this embodiment is less preferable to that previously described.

Apparatus 1110 (FIG. 6b) is a further alternative but less preferred embodiment and has tubular links 1112 which fit into one another via male 1114 and female 1116 connection sockets. Once the male socket 1114 is inserted into the female socket 1116, a wire W is inserted into the gap between the male 1114 and female 1116 sockets via a wire insertion hole 50. When inserted, the wire W extends around the circumference of the link 1112 and prevents the male 1114 socket from being withdrawn from the female 1116 socket. When disconnection of the links 1112 is desired, the wire W is removed via the hole 50 and the female socket 1116 may then be retracted from the female socket 1114. As for the apparatus 110 shown in FIG. 6a, this embodiment provides the rigidity required for the presently described application; however, the nature of the connection provided by the male 1114, female 1116 connection sockets and wire W does not as easily allow angular displacement of one end of the apparatus 1110 with respect to the other as required in order to maintain the flexibility of the system. Therefore this embodiment is less preferable.

Modifications and improvements may be made to the embodiments hereinbefore described without departing from the scope of the invention, for example:

The preferred embodiment described includes a number of male-female links 12 along the majority of the length of the apparatus 10 which are then connected to tail pieces 28 via female-female links 26 for subsequent connection to a separate components. However, it would be possible to alternately arrange female-female links 26 with male-male links (not shown). This has the advantage that a similar quantity of male-male and female-female links 26 would be required in order to construct the apparatus 10 and there may be manufacturing advantages in providing such a system.

1. A support apparatus comprising:
at least first and second substantially rigid tubular members each comprising a through bore; and
connection mechanism for selectively connecting the first and second tubular members such that a moveable joint is provided between the first and second tubular members.

2. Support apparatus according to claim 1, comprising a conduit adapted to be inserted into a substantially flexible tubing, wherein the support apparatus is adapted to prevent crushing or collapse of the flexible tubing in environments having a higher exterior pressure with respect to the interior pressure of the flexible tubing.

3. Support apparatus according to claim 1, wherein the moveable joint provided by the connection mechanism permits articulated movement to occur between the first and second tubular members.

4. Support apparatus according to claim 3, wherein the articulated movement comprises pivoting movement between the first and second members.

5. Support apparatus according to claim 4, wherein the pivoting relationship between the first and second members comprises movement of a longitudinal axis of the first tubular member with respect to a longitudinal axis of the second tubular member within a cone projecting away from the end of the second tubular member, the closest ends of the pair of longitudinal axes remaining intersected at the same point whilst the first and second tubular members are connected.

6. Support apparatus according to claim 1, wherein the connection mechanism comprises a ball joint provided on one of the first and second tubular members and a socket joint provided on the other of the first and second tubular members.

7. Support apparatus according to claim 1, wherein the connection mechanism is adapted to substantially prevent longitudinal movement of the first tubular member with respect to the second tubular member.

8. Support apparatus according to claim 1, wherein the connection mechanism comprises a socket connection portion on one of the first and second tubular members and a ball connection portion on the other of the first and second tubular members.

9. Support apparatus according to claim 8, wherein the connection mechanism further comprises a retaining lip on the socket connection portion adapted to be retained within a lip retaining groove provided adjacent the ball connection portion.

10. Support apparatus according to claim 9, wherein the retaining lip is provided with a radius which assists connection of the socket connection portion to the ball connection portion.

11. Support apparatus according to claim 1, wherein the first tubular member is provided with a female connection portion and a male connection portion, the latter of which is connected to a female connection portion of the second tubular member.

12. Support apparatus according to claim 1, wherein the first tubular member is provided with first and second male connection portions, one of which is connected to a second tubular member having first and second female connection portions.

13. Support apparatus according to claim 1, wherein a plurality of tubular members are provided such that when the plurality of tubular members are connected to one another, one end of the apparatus may be angularly displaced with respect to the other without substantially tensioning or compressing the tubular members.

14. Support apparatus according to claim 2, wherein the support apparatus is provided with at least one tubing connection socket which is adapted to allow connection of a portion of the apparatus to the flexible tubing.

15. Support apparatus according to claim 14, wherein the tubing connection socket is provided with a gripping portion adapted to allow the flexible tubing to be gripped on the tubing connection socket.

16. Support apparatus according to claim 14, wherein the tubing connection socket is provided with an attachment mechanism adapted to allow attachment of the tubing connection socket to further discrete components.

17. Support apparatus according to claim 14, wherein a tubular connection member having first and second female connection portions provides connection between a male connection portion of a tubular member and a male connection portion of the tubing connection socket.

18. A method of supporting tubing, the method comprising the steps of:
inserting at least first and second substantially rigid tubular members into the tubing, each substantially rigid member comprising a through bore; and
connecting the first and second tubular members such that a moveable joint is provided between the first and second tubular members.

19. A method according to claim 18, wherein the tubing is flexible and collapse of the flexible tubing is substantially prevented by an outer surface of the tubular members providing a support to an inner surface of the flexible tubing.

20. A method according to claim 19, wherein the method further comprises placing the flexible tubing in water in use of the flexible tubing to provide a fluid communication path, such that the tubular members substantially prevent collapse of the flexible tubing when a differential pressure is acting to attempt to collapse the flexible tubing.
